(19) United States
(12) Patent Application Publication
(10) Pub. No.: US 2023/0136614 A1
(43) Pub. Date: May 4, 2023

(54) EXTENDED RANGE OF FUEL CELL MACHINE

(71) Applicant: Caterpillar Global Mining Equipment LLC, Tucson, AZ (US)

(72) Inventor: Cameron Thomas Lane, Oro Valley, AZ (US)

(73) Assignee: Caterpillar Global Mining Equipment LLC, Tucson, AZ (US)

(21) Appl. No.: 17/519,338

(22) Filed: Nov. 4, 2021

(51) Int. Cl. B60L 58/40; B60L 58/12; B60L 58/30; B60L 53/14; B60L 53/80; B60L 53/50; H01M 8/04858; H01M 16/00

(52) U.S. Cl. CPC B60L 58/40; B60L 58/12; B60L 58/30; B60L 53/14; B60L 53/80; B60L 53/50; H01M 8/04932; H01M 16/006; B60L 2250/16; B60L 2260/54; H01M 2250/20

(57) ABSTRACT

A fuel cell machine control system and method to provide extended range and operating times of a fuel cell machine with a fuel cell and battery is disclosed. In some cases, the energy capacity of the battery relative to the energy capacity of a fuel tank may be in the range of about 0.2 to about 1.5. The range and/or the operating time of the fuel cell machine is extended by using the fuel cell fuel to power the fuel cell machine and continuing operating the fuel cell machine after the fuel cell fuel is depleted using the battery. In some cases, the fuel cell machine may autonomously be moved to a refueling/charging station when the remaining charge in the battery is within a threshold level of being depleted. Additionally, a total energy available to operate the fuel cell machine may be determined and displayed.

### TECHNICAL FIELD

The present disclosure relates to a machine powered by a fuel cell. More specifically, the present disclosure relates to extending ranges of fuel cell machines, such as mining trucks.

### BACKGROUND

Machines, such as mining trucks, loaders, dozers, compaction machines, or other construction or mining equipment, are often powered by any variety of fuel, including fuel cells that operate using hydrogen or hydrogen containing (e.g., natural gas) fuel. Machines powered by fuel cells are used for building, construction, mining and other activities. For example, mining trucks are often used for hauling mined materials from mining sites. It is desirable to power these types of machines using alternative fuels, such as hydrogen powering fuel cells. Fuel cell machines, for example, may benefit from reduced emissions of carbon (e.g., carbon dioxide), particulates (e.g., diesel soot), nitrous oxide (e.g., NOx), and/or organic (e.g., volatile organic compounds (VOC)) emissions relative to traditional fuel (e.g., diesel, gasoline, etc.) powered machines.

While fuel cell powered machinery may provide various improvements, such as environmental advantages, fuel cell powered machinery may also suffer from some challenges, such as low energy density of hydrogen fuel, low range of fuel cell machines between refueling, and long refueling times. It is, therefore, desirable to increase the operating time of fuel cell machines between refueling.

One mechanism for operating a fuel cell system is described in U.S. Pat. No. 7,224,524 (hereinafter referred to as “the '524 reference”). The '524 reference describes switching from a primary power source to a secondary power source, such as a fuel cell. The '524 reference describes procedures associated with the switchover to a fuel cell power source. However, the systems and methods described in the '524 reference does not pertain to the operation or control of a fuel cell powered machine. Thus, the disclosure of the '524 reference does not describe how to extend the range of a fuel cell machine.

Examples of the present disclosure are directed toward overcoming one or more of the deficiencies noted above.

### SUMMARY

In an aspect of the present disclosure, a machine includes a motor, a fuel tank configured to hold fuel, a fuel tank controller configured to report an amount of fuel in the fuel tank, a fuel cell configured to power the motor using fuel held in the fuel tank, a battery configured to power the motor, a battery controller configured to report an amount of charge in the battery, and an engine control module (ECM). The ECM is configured to start performing a task, the task including operating the motor using one or both of the fuel cell and the battery. The ECM is further configured to receive, from the fuel tank controller, a first indication that the fuel has been depleted and continue, based at least in part on the first indication that the fuel has been depleted, performing the task using the battery. The ECM is still further configured to receive from the battery controller a second indication that the battery is within a threshold level of being depleted and cause, based at least in part on the second indication that the battery being within the threshold level of being depleted, the task to be halted.

In another aspect of the present disclosure, a method of operating a machine includes performing, by the machine, a task using energy from one or both of a fuel cell and a battery, determining that a fuel cell fuel for operating the fuel cell has been depleted, and continuing, based at least in part on the fuel being depleted, performing the task using energy from the battery. The method further includes determining that the battery is within a threshold level of being depleted and moving, based at least in part on the battery being within the threshold level of being depleted, the machine to a refueling/charging station.

In yet another aspect of the present disclosure, a controller of a machine includes one or more processors and one or more computer-readable media storing computer-executable instructions that, when executed by the one or more processors, cause the one or more processors to receive, from a fuel tank controller, a first indication of a remaining amount of fuel cell fuel in a fuel tank and determine a first amount of energy associated with the fuel cell fuel based at least in part on the remaining amount of fuel cell fuel in the fuel tank. The computer-executable instructions that, when executed by the one or more processors, further cause the one or more processors to receive, from a battery controller, a second indication of a remaining amount of charge in a battery and determine a second amount of energy associated with the battery based at least in part on the remaining amount of charge in the battery. The computer-executable instructions that, when executed by the one or more processors, still further cause the one or more processors to determine that a total energy available to operate the machine based at least in part on the second amount of energy and cause to display the total energy available to operate the machine on an energy gauge.

### BRIEF DESCRIPTION OF DRAWINGS

FIG. 1 is a schematic illustration of an example fuel cell machine, in accordance with examples of the disclosure.

FIG. 2 is a schematic illustration of a worksite with the fuel cell machine depicted in FIG. 1, according to examples of the disclosure.

FIG. 3 is a schematic illustration depicting an example control environment of the fuel cell machine of FIG. 1, according to examples of the disclosure.

FIG. 4 is a flow diagram depicting an example method for operating the fuel cell machine of FIG. 1, according to examples of the disclosure.

FIG. 5 is a flow diagram depicting an example method for displaying a level of energy available for operating the fuel cell machine of FIG. 1, according to examples of the disclosure.

FIG. 6 is a flow diagram depicting an example method for performing a task using the fuel cell machine of FIG. 1, according to examples of the disclosure.

FIG. 7 is a flow diagram depicting an example method for operating the fuel cell machine of FIG. 1, according to examples of the disclosure.

FIG. 8 is a block diagram of an example engine control module (ECM) that may operate the fuel cell machine of FIG. 1, according to examples of the disclosure.

### DETAILED DESCRIPTION

Wherever possible, the same reference numbers will be used throughout the drawings to refer to the same or like parts.

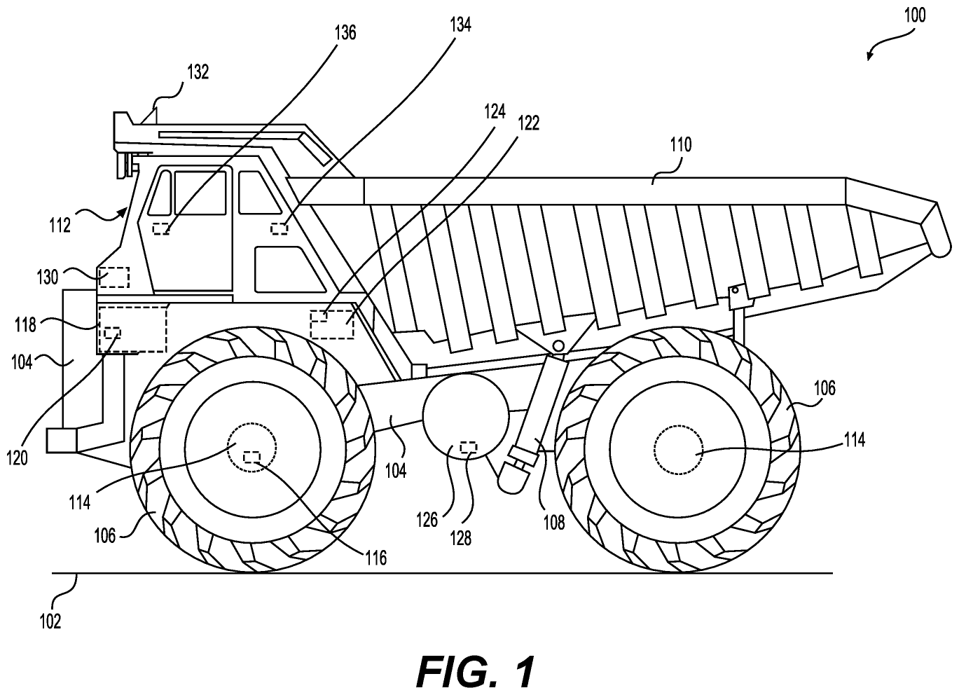

FIG. 1 is a schematic illustration of an example fuel cell machine 100, in accordance with examples of the disclosure. The fuel cell machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. The fuel cell machine 100 is configured for propulsion using hydrogen and/or hydrogen containing compounds, such as various hydrocarbons (methane, ethane, propane, butane, pentane, hexane, combinations thereof, or the like), compressed natural gas (CNG), natural gas, liquified natural gas (LNG), combinations thereof, or the like.

The fuel cell machine 100 is illustrated as a mining truck, which is used, for example, for moving mined materials, heavy construction materials, and/or equipment, and/or for road construction, building construction, other mining, paving and/or construction applications. For example, the fuel cell machine 100 is used in situations where materials, such as mineral ores, loose stone, gravel, soil, sand, concrete, and/or other materials of a worksite need to be transported over a surface 102 at the worksite. As discussed herein, the fuel cell machine 100 may also be in the form of a dozer, where the fuel cell machine 100 is used to redistribute and/or move material on the surface 102. Further still, the fuel cell machine 100 may be in the form of a compaction machine that can traverse the surface 102 and impart vibrational forces to compact the surface 102. Such a compaction machine includes drums, which may vibrate to impart energy to the surface 102 for compaction. For example, a fuel cell compaction machine is configured to compact freshly deposited asphalt and/or other materials disposed on and/or associated with the surface 102, such as to build a road or parking lot. It should be understood that the fuel cell machine 100 can be in the form of any other type of suitable construction, mining, farming, military, and/or transportation machine. In the interest of brevity, without individually discussing every type of construction and/or mining machine, it should be understood that the fuel cell drive mechanisms, as described herein, are configured for use in a wide variety of fuel cell powered machines 100.

As shown in FIG. 1, the fuel cell machine 100 includes a frame 104 and wheels 106. The wheels 106 are mechanically coupled to a drive train (not shown) to propel the fuel cell machine 100. When the wheels 106 of the fuel cell machine 100 are caused to rotate, the fuel cell machine 100 traverses the surface 102. Although illustrated in FIG. 1 as having a hub with a rubber tire, in other examples, the wheels 106 may instead be in the form of drums, chain drives, combinations thereof, or the like.

The frame 104 of the fuel cell machine 100 is constructed from any suitable materials, such as iron, steel, aluminum, other metals, ceramics, plastics, the combination thereof, or the like. The frame 104 is of a unibody construction in some cases, and in other cases, is constructed by joining two or more separate body pieces. Parts of the frame 104 are joined by any suitable variety of mechanisms, including, for example, welding, bolts, screws, other fasteners, epoxy, combinations thereof, or the like.

The fuel cell machine 100 may include a hydraulic system 108 that move a dump box 110 or other moveable elements configured to move, lift, carry, and/or dump materials. The dump box 110 is used, for example, to pick up and carry dirt or mined ore from one location on the surface 102 to another location of the surface 102. The dump box 110 is actuated by the hydraulic system 108, or any other suitable mechanical system. In some cases, the hydraulic system 108 is powered by an electric motor (not shown), such as by powering hydraulic pump(s) (not shown) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the fuel cell machine 100 also includes an operator station 112. The operator station 112 is configured to seat an operator (not shown) therein. The operator seated in the operator station 112 interacts with various control interfaces and/or actuators within the operator station 112 to control movement of various components of the fuel cell machine 100 and/or the overall movement of the fuel cell machine 100 itself.

Thus, control interfaces and/or actuators within the operator station 112 allow the control of the propulsion of the fuel cell machine 100 by controlling operation of one or more motors 114. A motor controller 116 may be controlled according to operator inputs received at the operator station 112. The motors 114 may be powered by a battery pack or battery 118, with a battery controller 120, and/or a fuel cell 122, with a fuel cell controller 124.

The motors 114 may be of any suitable type, such as induction motors, permanent magnet motors, switched reluctance (SR) motors, combinations thereof, or the like. The motors 114 are of any suitable voltage, current, and/or power rating. The motors 114 when operating together are configured to propel the fuel cell machine 100 as needed for tasks that are to be performed by the fuel cell machine 100. For example, the motors 114 may be rated for a range of about 500 volts to about 3000 volts. The motor controller 116 include one or more control electronics to control the operation of the motors 114. In some cases, each motor 114 may be controlled by its own motor controller 116. In other cases, all the motors of the fuel cell machine 100 may be controlled by a single motor controller 116. The motor controller 116 may further include one or more inverters or other circuitry to control the energizing of magnetic flux generating elements (e.g., coils) of the motors 114. The motors 114 are mechanically coupled to a variety of drive train components, such as a drive shaft and/or axles or directly to the wheels 106 to rotate the wheels 106 and propel the fuel cell machine 100. The drivetrain includes any variety of other components including, but not limited to a differential, connector(s), constant velocity (CV) joints, etc. Although not shown here, there may be one or more motors 114 that are not used for propulsion of the fuel cell machine 100, but rather to operate pumps and/or other auxiliary components, such as to operate the hydraulic systems 108.

According to examples of the disclosure, the power to energize the motors 114 is received from the battery 118, the fuel cell 122, or both the battery 118 and the fuel cell 122. In some cases, the motors 114 may operate solely from the power produced by the fuel cell 122. In other cases, the power received from the fuel cell 122 to operate the motors 114 may be supplemented by power from the battery 118. Fuel cells generally provide a relatively steady level of power and generally do not ramp up or ramp down significantly or quickly from a baseline level of power. As a result, when a high level of power is needed to power the motors 114, power may be drawn from the fuel cell 122 and the battery 118 contemporaneously. According to examples of the disclosure, in some cases, the battery 118 may provide power for operating the motors 114 and/or other power consuming components (e.g., controllers, cooling systems, displays, actuators, sensors, etc.) of the fuel cell machine 100 while the fuel cell 122 does not provide power for operating the motors 114 and/or other power consuming components. In some cases, the motors 114 may be run using power from the fuel cell 122 or from a combination of the fuel cell 122 and the battery 118 until fuel for the fuel cell 122 is fully consumed. When the fuel is consumed, the fuel cell machine 100 may still be operated using power from the battery 118 until the battery 118 no longer has sufficient power to operate the fuel cell machine 100. In this way, the range and/or the time of operation of the fuel cell machine 100 is extended beyond the range and/or time of operation of the fuel cell machine 100 according to the available fuel cell fuel available to the fuel cell machine 100.

In some cases, when the fuel cell machine 100 is operated with energy from the battery 118 only, the fuel cell machine 100 may be operated in a derated mode. This derated mode may reduce the peak power consumed by the fuel cell machine 100, such that the peak power draw by the subcomponents (e.g., motors 114, controller, etc.) do not exceed the power rating of the battery 118. In this way, the fuel cell machine 100 may prevent damaging and/or excessively depleting the battery 118 during its operation using energy only from the battery 118. This derated mode may manifest in a reduced/limited speed, a reduced/limited force, or the like of actions performed by the fuel cell machine 100.

The fuel cell machine 100 further includes a fuel tank 126 to store the fuel cell fuel. A fuel tank controller 128 is coupled with the fuel tank to determine and/or report the fuel level within the fuel tank 126. The fuel tank 126 may hold hydrogen (H) to power the fuel cell 122. In other cases, the fuel tank may hold other H containing fuels, such as compressed natural gas (CNG), liquefied petroleum gas (LPG), other gaseous fuels, other liquid fuels, other cryogenic fuels, methane, ethane, propane, butane, pentane, hexane, heptane, octane, ethene, propene, isobutene, butadiene, pentene, any suitable alkane, any suitable alkene, any suitable alkyne, any suitable cycloalkane, combinations thereof, or the like. It should also be noted that the fuel cell fuel held in the fuel tank 126 may include impurities, such as nitrogen, oxygen, argon, air, or the like. The fuel tank controller 128 may include one or more sensors, such as a pressure sensor, a hall sensor, a temperature sensor, a hygrometer, or the like, that allows the fuel tank controller to determine the amount of fuel cell fuel within the fuel tank 126. Although the fuel tank 126 is depicted as a single canister, it should be understood that the fuel tank 126 may be of any suitable size or shape and, in some cases, there may be more than one fuel tank 126 that are separate or fluidically coupled to each other.

The battery 118 may be of any suitable type and capacity. For example, the battery may be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery 118 may be organized as a collection of electrochemical cells arranged to provide the voltage, current, and/or power requirements of the motors 114. In some cases, the energy capacity of the battery 118 relative to the energy available from a full fuel tank 126 may be in the range of about 0.2 to about 1.5. In other cases, the energy capacity of the battery 118 relative to the energy available from a full fuel tank 126 may be in the range of about 0.5 to about 1. In still other cases, the energy capacity of the battery 118 relative to the energy available from a full fuel tank 126 may be in the range of about 0.7 to about 0.9. These aforementioned ratios may generally be more than what is typically used for fuel cell vehicles. It should be understood that the aforementioned ratios are examples, and the disclosure contemplates battery 118 energy capacity to fuel tank 126 energy capacity ratios in ranges outside of the aforementioned ranges.

The fuel cell 122 may be of any suitable type, such as a proton exchange membrane (PEM) fuel cell, a solid oxide fuel cell, an alkaline fuel cell, a solid-acid fuel cell, combinations thereof, or the like. As discussed herein, the energy output of the fuel cell 122 may be approximately similar to the energy output of the battery 118. In this type of energy ratio of the battery 118 and the fuel cell 122, the battery 118 can not only provide fast supplemental power to the motors 114 while the fuel cell 122 is also providing power to the motors 114, but the battery 118 is also able to operate the fuel cell machine 100 after the fuel cell fuel in the fuel tank 126 is fully depleted. In this way, according to examples of the disclosure, the range and/or the time of operation of the fuel cell machine 100 can be extended beyond that of the fuel cell operation alone or fuel cell operation supplemented with battery power at the same time.

The fuel cell machine 100 includes an engine control module (ECM) 130 that controls various aspects of the fuel cell machine 100. The ECM 130 is configured to receive battery status (e.g., state-of-charge (SOC) or other charge related metrics) from the battery controller 120, fuel level from the fuel tank controller 128, operator signal(s), such as an accelerator signal, based at least in part on the operator's interactions with one or more control interfaces and/or actuators of the fuel cell machine 100. In other cases, the ECM 130 may receive control signals from a remote control system by wireless signals, received via an antenna 132. The ECM 130 uses the operator signal(s), regardless of whether they are received from an operator in the operator station 112 or from a remote controller, to generate command signals to control various components of the fuel cell machine 100. For example, the ECM 130 may control the motors 114 via the motor controller 116, the fuel cell 122 via the fuel cell controller 124, the hydraulic system 108, and/or steering of the fuel cell machine 100 via a steering controller 134. It should be understood that the ECM 130 may control any variety of other subsystems of the fuel cell machine 100 that are not explicitly discussed here to provide the fuel cell machine 100 with the operational capability discussed herein.

The ECM 130, according to example of this disclosure, may be configured to provide an indication of remaining energy to operate the fuel cell machine 100 on an energy gauge 136. The energy gauge 136, according to examples of the disclosure, may be configured to display the amount of energy available to operate the fuel cell machine 100 based at least in part on the fuel cell fuel remaining in the fuel tank 126 and the amount of charge remaining in the battery 118. In some cases, the energy gauge 136 may provide an indication of an estimated amount of time the fuel cell machine 100 can be operated and/or an estimated amount of range the fuel cell machine 100 has remaining. These estimates may be generated based on the amount of fuel cell fuel remaining in the fuel tank 126, the amount of charge remaining in the battery 118, the recent usage of energy by the fuel cell machine 100, and/or an estimate of the energy expended per unit time (e.g., power requirement) of a task in which the fuel cell machine 100 is engaged. The energy gauge 136 may be configured to display, to an operator seated in the operator station 112, the amount of energy, time, and/or range remaining for operating the fuel cell machine 100. Additionally or alternatively, the energy gauge 136 and/or the ECM 130 may be configured to indicate, such as wirelessly via the antenna 132, the amount of energy, time, and/or range remaining for operating the fuel cell machine 100 to a remote operating system.

The ECM 130 includes single or multiple microprocessors, field programmable gate arrays (FPGAs), digital signal processors (DSPs), and/or other components configured to control the fuel cell machine 100. Numerous commercially available microprocessors can be configured to perform the functions of the ECM 130. Various known circuits are operably connected to and/or otherwise associated with the ECM 130 and/or the other circuitry of the fuel cell machine 100. Such circuits and/or circuit components include power supply circuitry, inverter circuitry, signal-conditioning circuitry, actuator driver circuitry, etc. The present disclosure, in any manner, is not restricted to the type of ECM 130 or the positioning depicted of the ECM 130 and/or the other components relative to the fuel cell machine 100. The ECM 130 is configured to control the use of energy from the battery 118 and the fuel cell 122 in a manner that enhances the range of the fuel cell machine 100.

The fuel cell machine 100 further includes any number of other components within the operator station 112 and/or at one or more other locations on the frame 104. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems are powered by any suitable mechanism, such as by using a direct current (DC) power supply powered by the fuel cell 122 and/or battery 118.

It should be understood that the fuel cell machine 100 as discussed herein, provides for an extended range and/or extended time of operation compared to conventional fuel cell equipment. This range enhancement is enabled by operating the fuel cell machine 100 using fuel cell fuel until all of the fuel cell fuel is depleted and then operating the fuel cell machine 100 until the battery is depleted or close to being depleted.

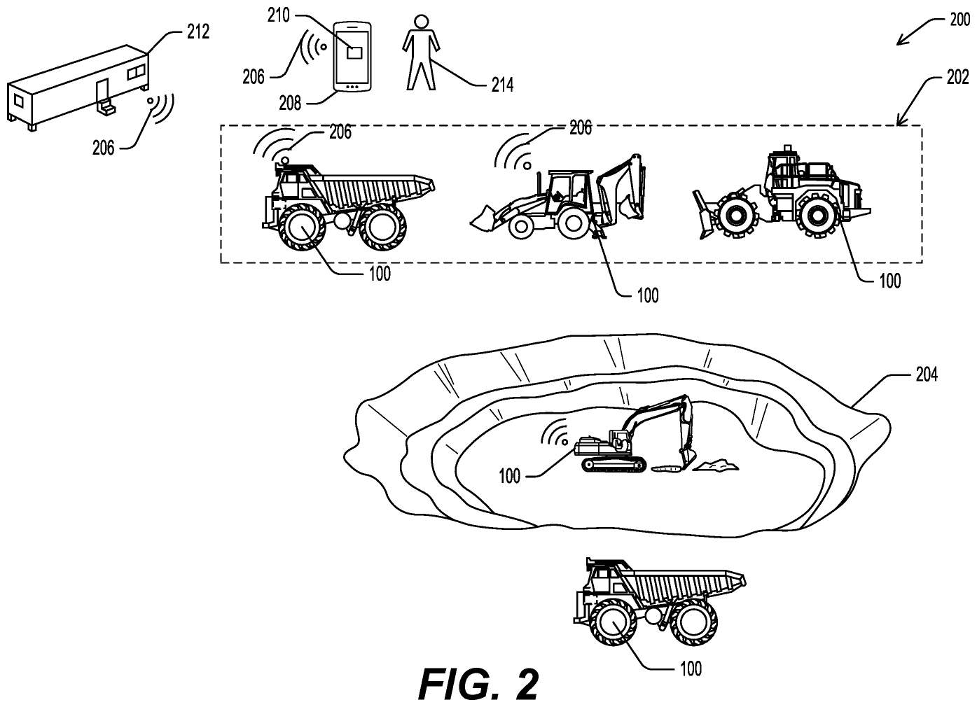

FIG. 2 is a schematic illustration of a worksite 200 with the fuel cell machine 100 depicted in FIG. 1, according to examples of the disclosure. The worksite 200 may have more than one fuel cell machine 100. For example, as depicted in FIG. 2, the worksite 200 may include other fuel cell machines 100, such as in the form of a mining truck, an excavator, a backhoe, a dozer, or the like. It should be understood that in some cases, the worksite 200 may include both fuel cell machines 100, as well as conventional machines (e.g., internal combustion engine machines) or any other type of machine (e.g., battery only electric machines).

The worksite 200 includes a variety of different locations in which or to which the fuel cell machine 100 may be maneuvered, staged, maintained, stored, parked, supplied, and/or used to perform work, such as by operator control and/or in an automated fashion. The worksite 200 includes a refueling/charging station 202 and one or more work area 204, where fuel cell machine(s) 100 may perform tasks. For example, as depicted here, a fuel cell machine 100 in the form of an excavator may be used to dig mineral ore, while another fuel cell machine 100 in the form of a mining truck may be loaded with the mineral ore for hauling. Other tasks may involve other work activities, such as digging dirt, distributing asphalt, redistributing gravel, harvesting wheat, or the like. Although the work area 204 is depicted as an open pit mine, it should be understood that the work area 204 may be any suitable location in any suitable application, such as construction, mining, farming, transportation, or the like. For example, the work area 204 may be in the form of a paving site, an industrial site, a factory floor, a building construction site, a road construction site, a quarry, a building, a city, combinations thereof, or the like.

The refueling/charging station 202 may allow the fuel cell machines 100 to refuel, such as by filling the fuel tank 126 with additional fuel cell fuel, such as hydrogen and/or other hydrogen containing molecules. For example, pumps (not shown) or other flow devices may be attached to the fuel tank 126 of the fuel cell machine 100 to provide the fuel tank 126 with additional fuel. The refueling/charging station 202 may also allow the fuel cell machine 100 to recharge its battery 118. For example, charging wire(s) may be attached to the fuel cell machine 100 to provide the battery 118 with electricity to recharge. In some cases, the fuel cell machine 100 may be both recharged and refueled at the same time at the refueling/charging station 202. In some other cases, such as when a worksite 200 does not have electrical infrastructure available, the fuel cell machine 100 may be configured to recharge the battery 118 using the fuel cell 122 while the fuel cell machine 100 is refueled.

The fuel cell machine 100 may be able to communicate via wireless signals 206 with an electronic device 208 configured to generate and send remote task commands to control the fuel cell machine 100. The electronic device 208 may have control software 210 operating thereon to generate the task commands to send via the wireless signals 206. In some cases, the electronic device 208 may be housed in a trailer or control center 212 at the worksite 200. In other cases, the electronic device may be located remote to the worksite 200. The fuel cell machine 100 may receive the wireless signal 206 carrying a task command via the antenna 132. The ECM 130 may demodulate and/or decode the received wireless signal 206 to determine the task command. The ECM may then control various subsystems of the fuel cell machine 100 to perform the task indicated in the task command. It should be understood that the fuel cell machine 100 may be controlled by an operator positioned in the operator station 112 or by the electronic device 208 controlled by a remote operator 214. The electronic device 208 may be controlled by a remote operator 214 (e.g., worksite 200 manager, construction worker, miner, farmer, paver, etc.) in some cases.

The electronic device 208, with the control software 210 running thereon, may send one or more task commands to the fuel cell machine 100 to assign the fuel cell machine 100 one or more tasks. For example, the electronic device 208 may generate a mobilization command and transmit the same via the wireless signal 206. Thus, the electronic device 208, with the software application running thereon, may receive input from the remote operator 214, such as via one or more human machine interface(s) (HMIs), to proceed with generating the mobilization command. The human operator 214 may provide any variety of parameters, corresponding to desired operating characteristics of the fuel cell machine 100 for the mobilization of the fuel cell machine 100, such as destination location, speed, etc. These parameters may be encoded by the electronic device 208 into a mobilization command, or a particular task command, that is transmitted to the fuel cell machines 100 via the wireless signal 206.

In some instances, the communications between the electronic device 208 and the fuel cell machines 100 may be via protocol based communications (e.g., direct Wi-Fi, Wi-Fi, the Internet, Bluetooth, etc.), and in other instances, the communications may be non-protocol-based communications (e.g., remote control). In examples of the disclosure, the worksite 200 with communications between one or more electronic devices 208 and one or more fuel cell machines 100 may result in a worksite level network, such as a local area network (LAN) or a wide-area network (WAN). Although the electronic device 208 is depicted herein as a smartphone, it should be understood that the electronic device 208 may be any suitable type of electronic device. For example, the electronic device 208 may be a computer, a mobile device, a server, a tablet computer, a notebook computer, a handheld computer, a workstation, a desktop computer, a laptop, any variety of user equipment (UE), a network appliance, an e-reader, a wearable computer, a network node, a microcontroller, a smartphone, or another computing device. The control software 210 that operates on the electronic device 208 to enable it to control the operations of the fuel cell machines 100, such as with task commands, may be downloaded to the electronic device 208 from any suitable website, such as a commercial app downloading website, or the like.

The ECM 130 may receive one or more task commands from the electronic device 208 and/or local commands from an operator in the operator station 112, and perform a corresponding task. According to examples of the disclosure, the ECM 130, in some cases, may determine the amount of time the fuel cell machine 100 can perform the task, based at least in part on the amount of fuel cell fuel remaining in the fuel tank 126, the amount of charge remaining in the battery 118, and/or an estimate of the amount of energy required to perform the task. In some cases, the ECM 130 may cause the fuel cell machine 100 to perform the assigned task autonomously and continue performing the task until the total energy available, as a combined energy of the fuel cell fuel in the fuel tank 126 and the energy remaining in the battery 118, is within a threshold of depletion. When the remaining energy available to the fuel cell machine 100 is within a threshold of depletion, the ECM 130 may indicate that the available energy is near depletion and/or autonomously return to the refueling/charging station 202 to refuel and/or recharge.

In some cases, the ECM 130 may repeatedly communicate with the battery controller 120 and/or the fuel cell controller 124 to repeatedly determine the level of energy available to the fuel cell machine 100 to perform a task. In the same or other cases, the ECM 130 may repeatedly provide an updated level of energy remaining to be displayed on the energy gauge 136. For the aforementioned operation and/or energy display, the ECM 130 may determine the available energy remaining as a sum of the energy available from the fuel cell fuel remaining in the fuel tank 126 and the remaining energy available from the battery 118 after the fuel cell fuel is depleted. In some cases, in addition to or instead of displaying the energy remaining to operate the fuel cell machine 100, the ECM 130 may cause the display, such as via the energy gauge 136, an estimated remaining time of operation of the fuel cell machine 100. This estimated remaining time of operation may be determined based at least in part on the total energy available for operating the fuel cell machine 100 (e.g., sum of energy available from the fuel cell fuel remaining and the remaining charge of the battery 118), along with an estimate of the amount of energy used per unit time to perform a task in which the fuel cell machine 100 is engaged. In some cases, the estimated remaining time of operation may be based at least in part on a distance that is to be traversed to empty a load, a remaining number of work cycles remaining to be performed, and/or any other suitable information that can be estimated based on historical average usage. In other cases, the ECM 130 may determine and display other suitable metrics of remaining usage, such as distance or range remaining and/or cycles of work remaining (e.g., number of trucks to load).

It will be understood that regardless of whether the fuel cell machine 100 is operated autonomously, by remote control, and/or by an operator in the operator station 112, the time of operation between recharging and/or refueling can be increased by using all of the energy from the fuel cell fuel to operate the fuel cell machine 100 and then continue operating the fuel cell machine 100 using energy from the battery 118 until the battery 118 is nearly depleted (e.g., within a threshold level of depletion). The battery 118 may not be fully depleted, as some energy will be needed to return the fuel cell machine 100 to the refueling/charging station 202. Thus, the systems and mechanisms discussed herein provide enhanced operation time, range, and/or task completion between visits to the refueling/charging station 202 relative to operating the fuel cell machine 100 only until the fuel cell fuel is depleted. This enhances the productivity and/or efficiency of the fuel cell machines 100 at the worksite 200.

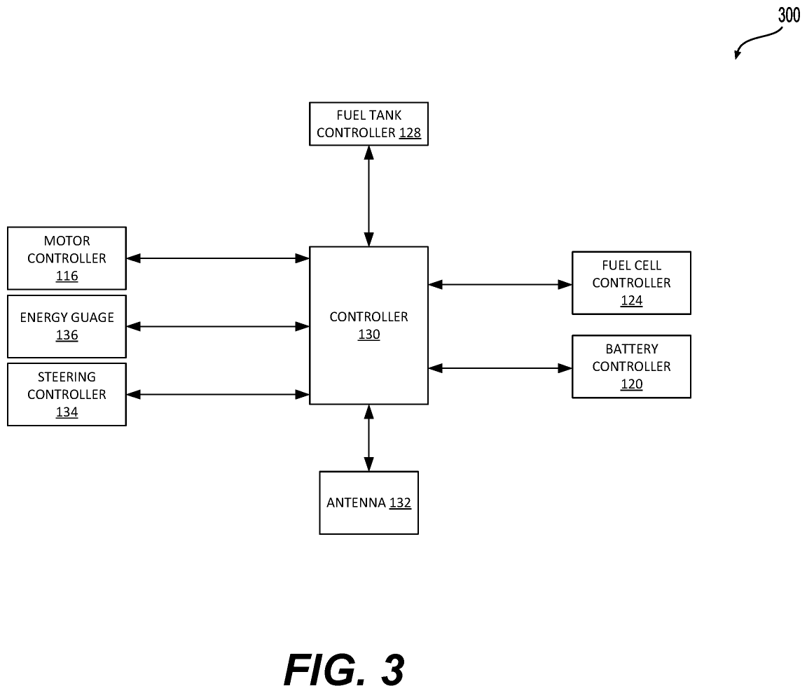

FIG. 3 is a schematic illustration depicting an example control environment 300 of the fuel cell machine 100 of FIG. 1, according to examples of the disclosure. As discussed herein, the ECM 130 may receive a variety of signals that it processes to enable that the fuel cell machine 100 operates to its energy capacity before returning to the refueling/charging station 202 to refuel and/or recharge. The ECM 130 may, in some examples, cause the fuel cell machine 100 to automatically move to the refueling/charging station 202 when the energy has been nearly depleted, such as within a threshold energy level of depletion. In the same or other examples, the ECM 130 may provide a repeated and/or continuous update on the level of total energy (e.g., from the fuel cell fuel and the charge remaining in the battery 118) remaining for operating the fuel cell machine 100, such as via the energy gauge 136. In yet other cases, the ECM 130 may estimate the amount of time it can perform a task based on the level of total energy available and an estimate of the energy required per unit time (e.g., power requirement) to perform the task.

As discussed herein, the ECM 130 may receive signals from the fuel tank controller 128 that indicate the level of fuel cell fuel in the fuel tank 126. This indication may be in terms of any suitable physical attribute of the fuel cell fuel, such as the pressure of the fuel cell fuel within the fuel tank 126, the weight of the fuel cell fuel, etc. The ECM 130, regardless of the physical attribute of the fuel cell fuel received from the fuel tank controller 128, may be configured to convert that physical attribute to a level of energy available to operate the fuel cell machine 100. The ECM 130 may further receive an indication of an attribute of the battery 118 from the battery controller 120, such as a state-of-charge (SOC) or any other suitable metric. The ECM 130 may determine, based at least in part on the communication from the battery controller 120, an amount of energy available from the battery 118 to operate the fuel cell machine 100. The ECM130 may be able to determine the total level of energy available to operate the fuel cell machine 100 based at least in part on the energy remaining in the battery 118 and the energy remaining in the fuel tank 126.

The ECM 130 may command the fuel cell controller 124 to operate the fuel cell 122 based at least in part on the amount of fuel cell fuel remaining in the fuel tank 126. In some cases, the ECM 130 may command the fuel cell controller 124 to operate the fuel cell 122 at constant and relatively efficient manner. If the level of current generated by the fuel cell 122 exceeds that needed for operating the fuel cell machine 100, the additional current may be used to charge the battery 118. The ECM 130 may also command the battery controller 120 to provide current to operate the fuel cell machine 100. In some cases, the battery 118 and the fuel cell 122 may provide electrical current contemporaneously to operate the fuel cell machine 100, such as to operate the motors 114.

In some cases, the ECM 130 may be configured to receive remote command(s) via the antenna 132. The ECM 130 may control the fuel cell machine 100 to perform a task based at least in part on the received remote command(s). In some cases, the task may be performed autonomously by the fuel cell machine 100, controlled by the ECM 130. The ECM 130 may control a variety of subsystems of the fuel cell machine 100, such as by controlling the motor controller 116 and/or the steering controller 134. According to examples of the disclosure, the ECM 130 may control the fuel cell machine 100 to perform the task even after all of the fuel cell fuel is depleted and until all of (or most) of the battery 118 is depleted. In additional examples of the disclosure, the ECM 130 may provide an indication of remaining energy, remaining estimated operation time, or the like, of the fuel cell machine 100, such as via the energy gauge 136 and/or by transmitting the same to the electronic device 208.

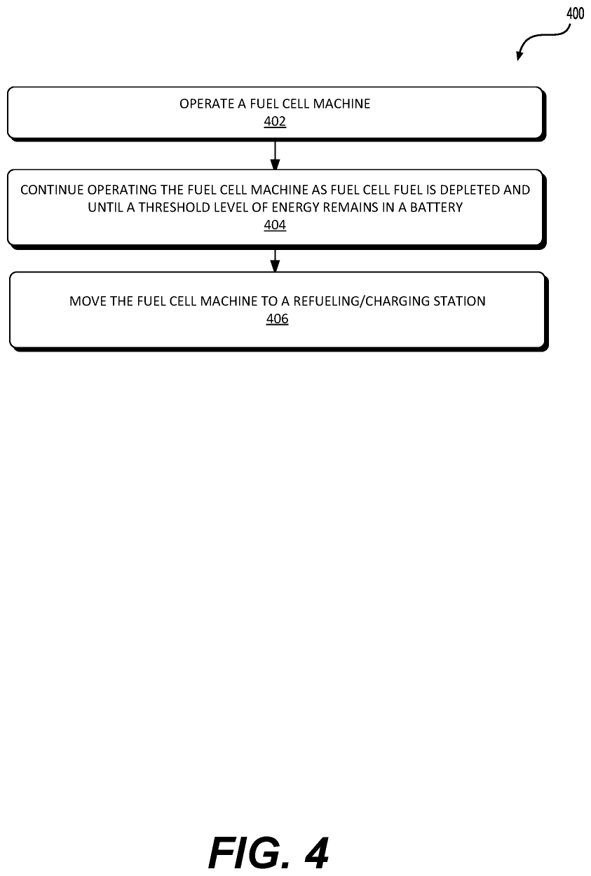

FIG. 4 is a flow diagram depicting an example method 400 for operating the fuel cell machine of FIG. 1, according to examples of the disclosure. The processes of method 400 may be performed by the ECM 130, individually or in conjunction with one or more other components of fuel cell machine 100. Method 400 allows the fuel cell machine 100 to operate beyond the time when its fuel cell fuel is depleted, in a manner where the fuel cell machine 100 operating time between refueling and/or recharging is increased and/or optimized.

At block 402, the ECM 130 operates the fuel cell machine 100. In some cases, this operation may be controlled by an operator in the operator station 112 of the fuel cell machine 100. In other cases, the ECM 130 may be operating the fuel cell machine 100 autonomously, such as based at least in part on one or more commands received from the electronic device 208. The fuel cell machine 100 may be engaged in any variety of tasks, such as hauling mined ore, harvesting wheat, flattening asphalt, or the like. The ECM 130 may control and/or command the operation of any variety of subsystems, such as the motors 114, of the fuel cell machine 100 to perform the task in which the fuel cell machine 100 is engaged. The fuel cell machine 100 may be primarily operated using electrical current from the fuel cell 122. However, at some times, energy from the battery 118 may be used to operate the fuel cell machine 100 at the same time as the fuel cell 122 to power the fuel cell machine 100, such as when a task or operation of the fuel cell machine 100 requires burst level, or higher than steady-state levels of power, that cannot be supplied by the fuel cell 122 alone.

At block 404, the ECM 130 continues to operate the fuel cell machine 100 as the fuel cell fuel is depleted and until a threshold level of energy remains in the battery 118. By operating the fuel cell machine 100 beyond the energy available from just the fuel cell fuel, the operating time, range, and/or task completion can be increased relative to operation where the fuel cell machine 100 is only operated until the fuel cell fuel is depleted. The threshold level of energy for determining when the fuel cell machine 100 should stop being used to perform its task may be a level of energy that would be safely sufficient to return the fuel cell machine to the refueling/charging station 202. In some cases, this threshold may be variable and/or settable by an operator, such as based on the particular features and/or size of the worksite 200 where the fuel cell machine 100 is being used.

In some cases, when the ECM 130 controls the fuel cell machine 100 to be operated with energy from the battery 118 only, the fuel cell machine 100 may be operated in a normal mode, where there are no additional limits placed on the operation of the fuel cell machine 100. In these cases, the power delivery capability of the battery 118 may be sufficient to operate the fuel cell machine 100 without limits. In other cases, when the ECM 130 controls the fuel cell machine 100 to be operated with energy from the battery 118 only, the fuel cell machine 100 may be operated in a derated mode. This derated mode, as described herein, may reduce the peak power consumed by the fuel cell machine 100, such that the peak power draw by the subcomponents (e.g., motors 114, controller, etc.) do not exceed the power rating of the battery 118. As a result, the ECM 130 may prevent damaging and/or excessively depleting the battery 118 during fuel cell machine 100 operation using energy only from the battery 118. This derated mode may manifest in a reduced/limited speed, a reduced/limited force, or the like of actions performed by the fuel cell machine 100. In some cases, the ECM 130 may engage in this derated mode by continuously monitoring the power usage of the fuel cell machine 100, and when power usage approaches the rated limits of the battery 118, the ECM 130 may control various other controllers (e.g., the motor controller 116) to reduce power usage. In other cases, the ECM 130 may implement a limit on speed, force, and/or other parameters of actions performed by the fuel cell machine 100 to stay within the bounds of the battery's power rating.

At block 406, when only a threshold level of energy is available to operate the fuel cell machine 100, the ECM 130 moves the fuel cell machine 100 to the refueling/charging station 202. In autonomous operation, the ECM 130 may move the fuel cell machine 100 to the refueling/charging station 202 without operator intervention. In other cases, the ECM 130 may indicate to an operator that a threshold level of energy is remaining for operating the fuel cell machine 100 and/or indicate to the operator that the fuel cell machine should be returned to the refueling/charging station 202. In some cases, the ECM 130 may also indicate, during the operation of the fuel cell machine 100, the amount of total energy available to operate the fuel cell machine 100, such as from the fuel cell fuel remaining in the fuel tank 126 and the battery 118.

It should be understood that the operations of method 400 allow the fuel cell machine 100 to operate for a longer time and/or have a greater range than would otherwise be possible with conventional ways of operating fuel cell machines 100. By fully or nearly fully depleting the battery 118 in performing the task before refueling and/or recharging the fuel cell machine 100, a greater time and or performed work is realized between refueling and/or recharging the fuel cell machine 100. Additionally, with the fuel cell machine 100 having a relatively high ratio of battery capacity 118 to fuel tank 126 capacity, such as a ratio of about 0.2 to about 1.5, the fuel cell machine 100 can operate for a longer time between refueling and/or recharging relative to conventional fuel cell machines. This results in improved productivity, efficiency, and equipment usage at the worksite 200.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

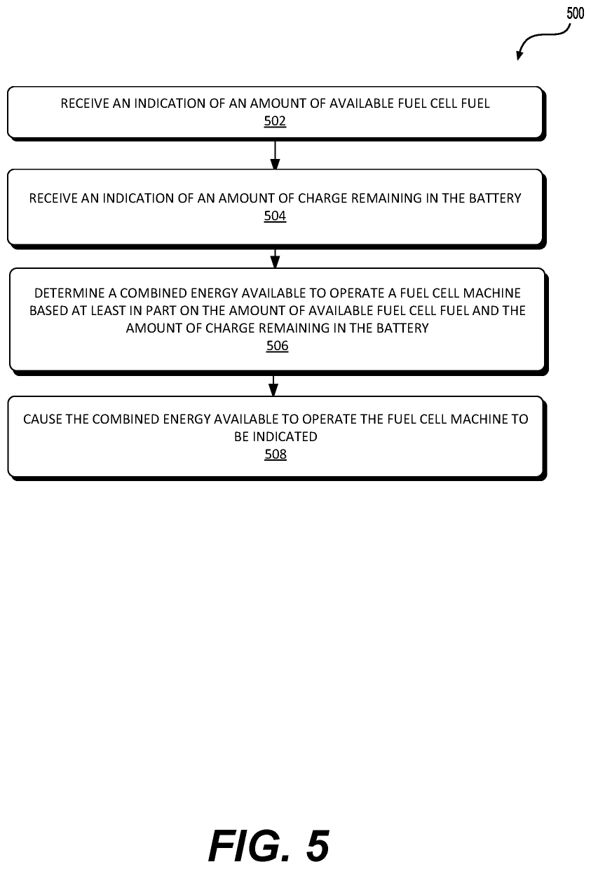

FIG. 5 is a flow diagram depicting an example method 500 for displaying a level of energy available for operating the fuel cell machine 100 of FIG. 1, according to examples of the disclosure. The processes of method 500 may be performed by the ECM 130, individually or in conjunction with one or more other components of fuel cell machine 100. Method 500 allows the fuel cell machine 100 to provide an indication of a combined amount of energy from the fuel cell fuel and the battery 118 available to operate the fuel cell machine 100.

At block 502, the ECM 130 may receive an indication of an amount of available fuel cell fuel. As discussed herein, this indication of the amount of fuel cell fuel may be received from the fuel tank controller 128. The amount of fuel cell fuel may be received in any suitable units, such as pressure, weight, etc. The ECM 130 may convert the amount of fuel cell fuel remaining into an equivalent level of energy available from the remaining fuel cell fuel.

At block 504, the ECM 130 may receive an indication of an amount of charge remaining in the battery 118. As discussed herein, this indication of the amount of charge may be received from the battery controller 120 as any suitable metric, such as SOC. Regardless of the metric received from the battery controller 120 indicating the level of remaining charge in the battery 118, the ECM 130 may convert metric to an equivalent level of energy available from the battery 118.

At block 506, the ECM 130 may determine a combined energy available to operate the fuel cell machine 100 based at least in part on the amount of available fuel cell fuel and the amount of charge remaining in the battery 118. In some examples, this may entail summing the remaining energy available from the fuel cell fuel and the energy remaining in the battery 118. Alternatively or in addition, the ECM 130 may determine a remaining estimated time of operation of the fuel cell machine 100. This determination may be based at least in part on the total available energy from the remaining fuel cell fuel and the battery 118, as well as an estimate of the energy usage per unit time (e.g., power) of the time being performed. In some cases, the power usage corresponding to the task may be an extrapolation of the power usage during the operation of the task by the fuel cell machine 100. Thus, the ECM 130 may monitor the power usage while performing the task and use that information to estimate the ongoing power usage, for the purposes of estimating the amount of remaining operation time of the fuel cell machine 100 performing the current task.

At block 508, the ECM 130 may cause the combined energy available to operate the fuel cell machine 100 to be indicated. ECM 130 may provide an updated level of energy remaining to be displayed on the energy gauge 136. In some cases, the ECM 130 may repeatedly perform method 500 to repeatedly provide an updated combined energy available to operate the fuel cell machine 100 to be indicated on the energy gauge 136. Alternatively or additionally, the ECM 130 may cause the energy gauge 136 to display the remaining estimated time of operation of the fuel cell machine 100, the remaining estimated range of the fuel cell machine 100, or the like. In some cases, the ECM 130 may cause the level of energy remaining to operate the fuel cell machine 100 to be transmitted to the electronic device 208 to be displayed remotely, such as to the operator 214.

It should be understood that the operations of method 500 allow the fuel cell machine 100 to display, such as to a human operator, the amount of total energy available to perform tasks, where this total energy is greater than what would be available had the fuel cell machine been operated according to conventional mechanisms of operation. This display of the total energy available allows the fuel cell machine 100 to operate for relatively longer times between refueling and/or recharging. This results in improved productivity, efficiency, and equipment usage at the worksite 200.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

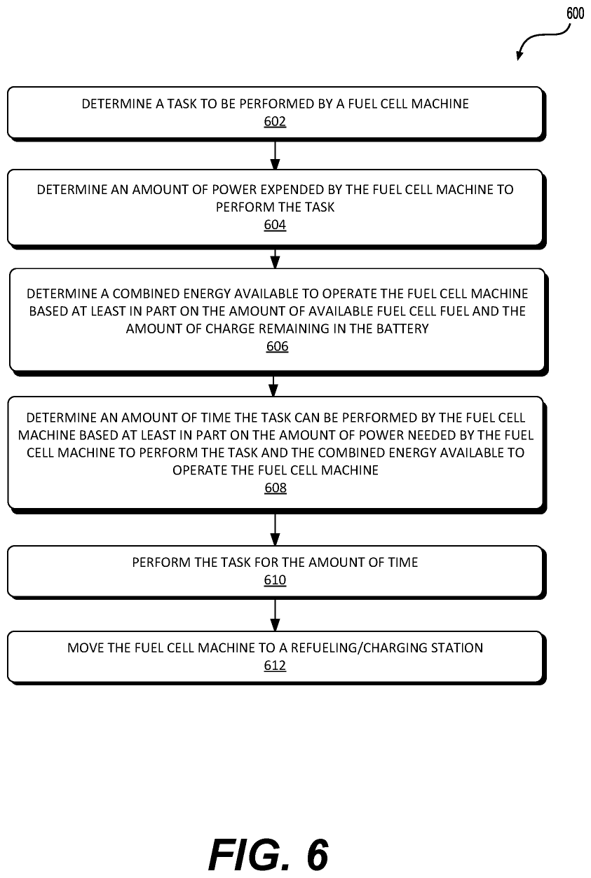

FIG. 6 is a flow diagram depicting an example method 600 for performing a task using the fuel cell machine 100 of FIG. 1, according to examples of the disclosure. The processes of method 600 may be performed by the ECM 130, individually or in conjunction with one or more other components of fuel cell machine 100.

At block 602, the ECM 130 may determine a task to be performed by the fuel cell machine 100. In some cases, the ECM 130 may be commanded, such as by the electronic device 208 or other remote controller, to perform the task in an autonomous or semi-autonomous way. In other cases, a human operator, such as a human operator seated in the operator station 112, may instruct the ECM 130 to perform the task.

At block 604, the ECM 130 may determine an amount of power needed by the fuel cell machine 100 to perform the task. The ECM 130 may determine the energy per unit time (e.g., an average power) to perform the task by any suitable mechanism, such as by using a look-up table that lists the energy per unit time usage for the task. In other cases, the ECM 130 may keep track of energy and/or power requirements when the fuel cell machine 100 previously performed the same or similar tasks and use those values as an estimate of the amount of energy expended per unit time by the fuel cell machine to perform the task. In yet other cases, the ECM 130 may commence the task and make a determination of the amount of energy being expended per unit time to perform the task.

At block 606, the ECM 130 may determine a combined energy available to operate the fuel cell machine 100 based at least in part on the amount of available fuel cell fuel and the amount of charge remaining in the battery 118. This combined energy may be determined, for example, by the processes of method 500, as discussed in conjunction with FIG. 5 herein. The combined available energy may be determined by summing the amount of energy available from the remaining fuel cell fuel in the fuel tank 126 and the energy available from the battery 118.

At block 608, the ECM may determine an amount of time the task can be performed by the fuel cell machine 100 based at least in part on the amount of power to be expended by the fuel cell machine 100 to perform the task and the combined energy available to operate the fuel cell machine 100. The ECM 130 may divide the total available energy by the power requirement to arrive at an estimate of the period of time that the fuel cell machine 100 can perform the task. In some cases, the ECM 130 may divide less than the total available energy (e.g., by reserving a safety margin and/or sufficient energy needed to return to the refueling/charging station 202) by the power requirement to arrive at an estimate of the period of time that the fuel cell machine 100 can perform the task. In some cases, the ECM 130 may estimate the amount of energy depleted from the battery while the fuel cell machine 100 is still primarily operating using fuel cell fuel to make the determination of the time the task can be performed by the fuel cell machine 100.

At block 610, the ECM 130 may cause the fuel cell machine 100 to perform the task for the amount of time. This task may be performed autonomously, semi-autonomously, and/or manually. By determining the time for operating the fuel cell machine 100, the total energy available is not depleted before the fuel cell machine 100 is returned to the refueling/charging station 202, while the total operating time between refueling and/or recharging of the fuel cell machine 100 can be increased and/or optimized. Initially, the task may be performed using energy from the fuel cell 122 or both the fuel cell 122 and the battery 118. As the fuel cell fuel is depleted, the task may be performed using energy from the battery 118 only.

In some cases, when the ECM 130 controls the fuel cell machine 100 to be operated with energy from the battery 118 only, the fuel cell machine 100 may be operated in a normal mode, where there are no additional limits placed on the operation of the fuel cell machine 100. In these cases, the power delivery capability of the battery 118 may be sufficient to operate the fuel cell machine 100 without limits. In other cases, when the ECM 130 controls the fuel cell machine 100 to be operated with energy from the battery 118 only, the fuel cell machine 100 may be operated in a derated mode. This derated mode, as described herein, may reduce the peak power consumed by the fuel cell machine 100, such that the peak power draw by the subcomponents (e.g., motors 114, controller, etc.) do not exceed the power rating of the battery 118. As a result, the ECM 130 may prevent damaging and/or excessively depleting the battery 118 during the fuel cell machine 100 operation using energy only from the battery 118. This derated mode may manifest in a reduced/limited speed, a reduced/limited force, or the like of actions performed by the fuel cell machine 100. In some cases, the ECM 130 may engage this derated mode by continuously monitoring the power usage of the fuel cell machine 100, and when power usage approaches the rated limits of the battery 118, the ECM 130 may control various other controllers (e.g., the motor controller 116) to reduce power usage. In other cases, the ECM 130 may implement a limit on speed, force, and/or other parameters of actions performed by the fuel cell machine 100 to stay within the bounds of the battery's power rating.

At block 612, the ECM 130 may cause the fuel cell machine 100 to move to the refueling/charging station 202. In autonomous operation, the ECM 130 may move the fuel cell machine 100 to the refueling/charging station 202 without operator intervention. In other cases, the ECM 130 may indicate to an operator that a threshold level of energy is remaining for operating the fuel cell machine 100 and/or indicate to the operator that the fuel cell machine should be returned to the refueling/charging station 202. In some cases, the ECM 130 may also indicate, during the operation of the fuel cell machine 100, the amount of total energy available to operate the fuel cell machine 100, such as from the fuel cell fuel remaining in the fuel tank 126 and the battery 118.

In some cases, the ECM 130 may continuously and/or periodically repeat the method 600 to refine the remaining time to operate the fuel cell machine 100 in performing the task. In some cases, the method 600 may be repeated using refined and/or updated estimates of power expenditure, such as based at least in part on extrapolating the amount of power used while the fuel cell machine 100 was performing the task. By repeating method 600, better estimates may be made of the operating time remaining of the fuel cell machine 100 as the fuel cell machine 100 performs the task.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

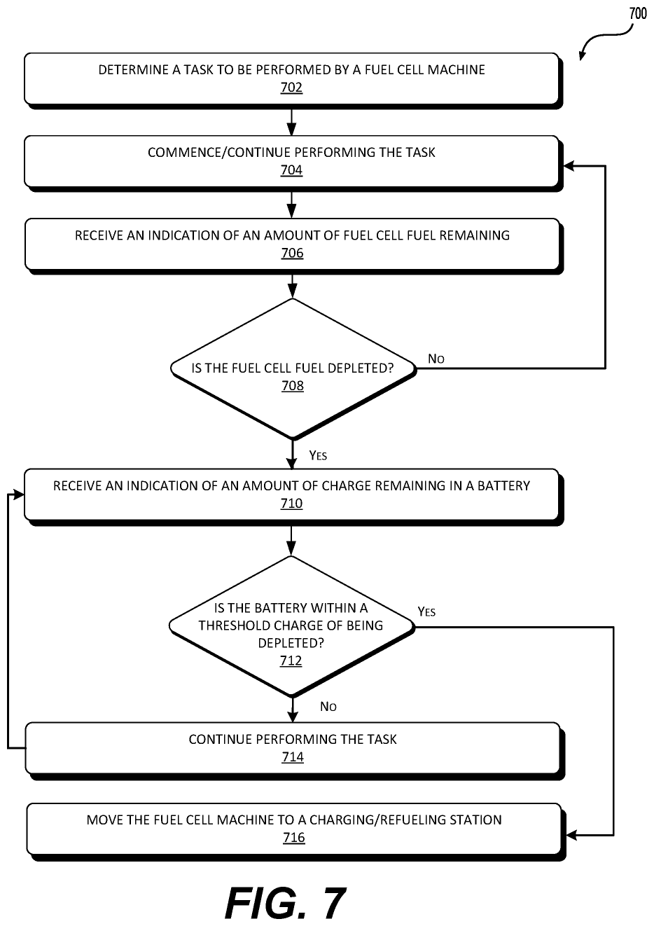

FIG. 7 is a flow diagram depicting an example method 700 for operating the fuel cell machine 100 of FIG. 1, according to examples of the disclosure. The processes of method 700 may be performed by the ECM 130, individually or in conjunction with one or more other components of fuel cell machine 100.

At block 702, the ECM 130 may determine a task to be performed by the fuel cell machine 100. In some cases, the ECM 130 may be commanded, such as by the electronic device 208 or other remote controller, to perform the task in an autonomous or semi-autonomous way. In other cases, a human operator, such as a human operator seated in the operator station 112, may instruct the ECM 130 to perform the task.

At block 704, the ECM 130 may cause the fuel cell machine 100 to commence and/or continue to perform the task. As discussed herein, the ECM 130 may cause the fuel cell machine 100 to perform the task in an autonomous or semi-autonomous fashion, in some cases. In other cases, the ECM 130 may receive indications of operator interactions with components of the fuel cell machine 100 to perform the task.

At block 706, the ECM 130 may receive an indication of an amount of fuel cell fuel remaining. As discussed herein, this indication of the amount of fuel cell fuel may be received from the fuel tank controller 128. The amount of fuel cell fuel may be received in any suitable units, such as pressure, weight, etc. The ECM 130 may convert the amount of fuel cell fuel remaining into an equivalent level of energy available from the remaining fuel cell fuel.

At block 708, the ECM 130 may determine if the fuel cell fuel is depleted. This determination may be based at least in part on the indication of the amount of fuel cell fuel remaining, as receive by the ECM 130 at block 706. If the indication of the amount of fuel cell fuel remaining is substantially zero or within a margin of zero, the ECM 130 may determine that the fuel cell fuel is depleted. Generally, during the operation of the fuel cell machine 100 the fuel cell fuel may be depleted before the battery 118 is depleted. If the ECM 130 determines that the fuel cell fuel is not depleted, the method 700 may return to block 704 to continue performing the task.

If at block 712, the ECM 130 determines that the fuel cell fuel is depleted, then at block 710, where the ECM 130 may receive an indication of an amount of charge remaining in the battery 118. As discussed herein, this indication of the amount of charge may be received from the battery controller 120 as any suitable metric, such as SOC. Regardless of the metric received from the battery controller 120 indicating the level of remaining charge in the battery 118, the ECM 130 may convert metric to an equivalent level of energy available from the battery 118.

At block 712, the ECM 130 may determine if the battery 118 is within a threshold charge of being depleted. The threshold charge level may be a level of charge needed to safely return the fuel cell machine 100 to the refueling/charging station 202. If the ECM 130 determines that the battery 118 is not within a threshold charge level of depletion, then the method 700 may proceed to block 714 to continue performing the task. The ECM 130 may periodically receive the indication of the amount of charge remaining in the battery, at block 710, and periodically make a determination of whether the battery 118 is within a threshold charge of being depleted, so that the fuel cell machine 100 can be refueled and/or recharged before the battery 118 is fully depleted.

In some cases, when the ECM 130 controls the fuel cell machine 100 to be operated with energy from the battery 118 only, the fuel cell machine 100 may be operated in a normal mode, where there are no additional limits placed on the operation of the fuel cell machine 100. In these cases, the power delivery capability of the battery 118 may be sufficient to operate the fuel cell machine without limits. In other cases, when the ECM 130 controls the fuel cell machine 100 to be operated with energy from the battery 118 only, the fuel cell machine 100 may be operated in a derated mode. This derated mode, as described herein, may reduce the peak power consumed by the fuel cell machine 100, such that the peak power draw by the subcomponents (e.g., motors 114, controller, etc.) do not exceed the power rating of the battery 118. As a result, the ECM 130 may prevent damaging and/or excessively depleting the battery 118 during the fuel cell machine 100 operation using energy only from the battery 118. This derated mode may manifest in a reduced/limited speed, a reduced/limited force, or the like of actions performed by the fuel cell machine 100. In some cases, the ECM 130 may engage this derated mode by continuously monitoring the power usage of the fuel cell machine 100, and when power usage approaches the rated limits of the battery 118, the ECM 130 may control various other controllers (e.g., the motor controller 116) to reduce power usage. In other cases, the ECM 130 may implement a limit on speed, force, and/or other parameters of actions performed by the fuel cell machine 100 to stay within the bounds of the battery's power rating.

If at block 712, the ECM 130 determines that the battery 118 is within a threshold of being depleted, then the method 700 may proceed to block 716, where the ECM 130 causes the fuel cell machine 100 to be moved to the refueling/charging station 202. In autonomous operation, the ECM 130 may move the fuel cell machine 100 to the refueling/charging station 202 without operator intervention. In other cases, the ECM 130 may indicate to an operator that a threshold level of energy is remaining for operating the fuel cell machine 100 and/or indicate to the operator that the fuel cell machine should be returned to the refueling/charging station 202. In some cases, the ECM 130 may also indicate, during the operation of the fuel cell machine 100, the amount of total energy available to operate the fuel cell machine 100, such as from the fuel cell fuel remaining in the fuel tank 126 and the battery 118.

It should be noted that some of the operations of method 700 may be performed out of the order presented, with additional elements, and/or without some elements. Some of the operations of method 700 may further take place substantially concurrently and, therefore, may conclude in an order different from the order of operations shown above.

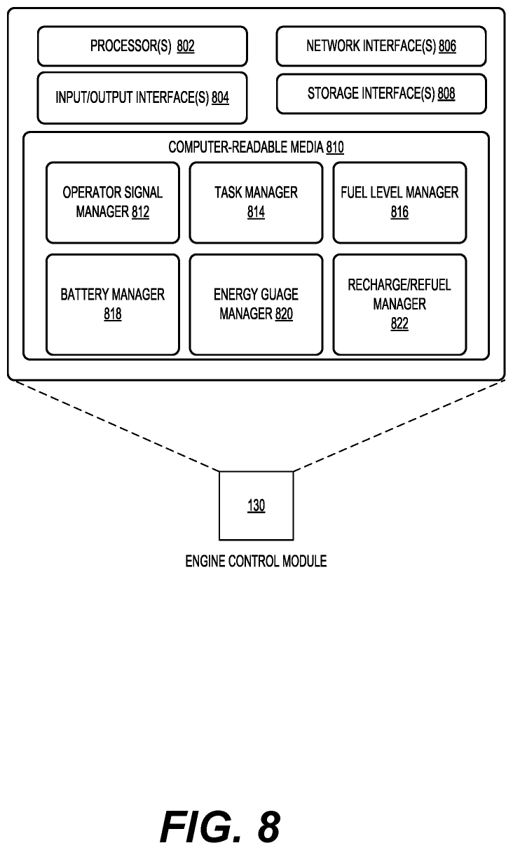

FIG. 8 is a block diagram of an example engine control module (ECM) that may operate the fuel cell machine of FIG. 1, according to examples of the disclosure. The descriptions of other controllers that may be included in the fuel cell machine 100 may be similar to the descriptions of the ECM 130 herein. The ECM 130 includes one or more processor(s) 802, one or more input/output (I/O) interface(s) 804, one or more communication interface(s) 806, one or more storage interface(s) 808, and computer-readable media 810.

In some implementations, the processors(s) 802 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 802 may possess its own local memory, which also may store program modules, program data, and/or one or more operating systems. The one or more processor(s) 802 may include one or more cores.

The one or more input/output (I/O) interface(s) 804 may enable the ECM 130 to detect interaction with an operator of the fuel cell machine 100. For example, the operator may press an accelerator, pull a lever, press a brake, or perform any other activity to indicate a desired action of the fuel cell machine 100. These activities on the part of the operator may be provided as operator signals 220 that are received by the ECM 130. Thus, the I/O interface(s) 804 may include and/or enable the ECM 130 to receive indications of what actions the fuel cell machine 100 is to perform.

The network interface(s) 806 may enable the ECM 130 to communicate via the one or more network(s). The network interface(s) 806 may include a combination of hardware, software, and/or firmware and may include software drivers for enabling any variety of protocol-based communications, and any variety of wireline and/or wireless ports/antennas. For example, the network interface(s) 806 may comprise one or more of WiFi, cellular radio, a wireless (e.g., IEEE 802.1x-based) interface, a Bluetooth® interface, and the like. In some cases, if a remote control is used to control the fuel cell machine 100, one or more operator signals may be received by the ECM 130 from a remote controller of the fuel cell machine 100.

The storage interface(s) 808 may enable the processor(s) 802 to interface and exchange data with the computer-readable medium 810, as well as any storage device(s) external to the ECM 130. The storage interface(s) 808 may further enable access to removable media.

The computer-readable media 810 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 810 may be implemented as computer-readable storage media (CRSM), which may be any available physical media accessible by the processor(s) 802 to execute instructions stored on the memory 810. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 802. The computer-readable media 810 may have an operating system (OS) and/or a variety of suitable applications stored thereon. The OS, when executed by the processor(s) 802 may enable management of hardware and/or software resources of the ECM 130.

Several components such as instruction, data stores, and so forth may be stored within the computer-readable media 810 and configured to execute on the processor(s) 802. The computer readable media 810 may have stored thereon an operator signal manager 812, a task manager 814, a fuel level manager 816, a battery manager 818, an energy gauge manager 820, and a recharge/refuel manager 822. It will be appreciated that each of the components 812, 814, 816, 818, 820, 822 may have instructions stored thereon that when executed by the processor(s) 802 may enable various functions pertaining to operating the fuel cell machine 100, as described herein.

The instructions stored in the operator signal manager 812, when executed by the processor(s) 802, may configure the ECM 130 to receive operator signals from one or more actuators of the fuel cell machine 100. These actuators may provide operator signals 220 that correspond to qualities of how the motors 114 and/or other components of the fuel cell machine 100 are to be run, such as the power output, RPMs, duration, etc. of running the motors 114 and/or direction of steering.

The instructions stored in the task manager 814, when executed by the processor(s) 802, may configure the ECM 130 to control the fuel cell machine 100 to perform tasks. In some cases, the tasks may be performed in an autonomous and/or semi-autonomous manner. In other cases, the ECM 130 may receive indications of operator interactions, such as from an operator in the operator station 112, to control the fuel cell machine 100.

The instructions stored in the fuel level manager 816, when executed by the processor(s) 802, may configure the ECM 130 to receive status pertaining to the amount of fuel cell fuel remaining in the fuel tank 126. This indication of the remaining fuel may be received from the fuel tank controller128 via any suitable communicative link. In some cases, the ECM 130 may solicit the remaining fuel level in the fuel tank 126 from the fuel tank controller 128 to receive an indication of the remaining fuel level.

The instructions stored in the battery manager 818, when executed by the processor(s) 802, may configure the ECM 130 to receive an indication of the amount of energy and/or charge level remaining in the battery 118. This information may be received from the battery controller 120. The ECM 130 may also be configured to provide any suitable type of control function for the battery 118. The ECM 130 may further control, such as via the battery controller 120, when the battery 118 is to be used to provide power to operate the fuel cell machine 100, such as operating various components of the fuel cell machine 100 (e.g., motors 114).

The instructions stored in the energy gauge manager 820, when executed by the processor(s) 802, may configure the ECM 130 to provide an indication of the total level of energy available to operate the fuel cell machine from the remaining fuel cell fuel and the remaining charge in the battery 118. The ECM 130 may also be configured to transmit this information, such as via wireless signals 206, to the electronic device 208 or other suitable remote controlling device.

The instructions stored in the recharge/refuel manager 822, when executed by the processor(s) 802, may configure the ECM 130 to autonomously or semi-autonomously move the fuel cell machine 100 to the refueling/charging station 202. In other cases, the ECM 130 may provide an indication to an operator that the fuel cell machine 100 is to be moved to the refueling/charging station 202, such as when the available energy remaining for the fuel cell machine 100 is within a threshold level of being depleted.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

### INDUSTRIAL APPLICABILITY

The present disclosure describes systems and methods for extending the range of fuel cell machines 100, such as mining machines (e.g., a mining truck) that operates using fuel cell fuel (e.g., hydrogen) and also has energy stored in a battery 118. These fuel cell machines 100 provide several advantages, such as reduced carbon, particulate, and/or VOC emissions. Additionally, these fuel cell machines 100 may be advantageous to operate at worksites 200 that are not electrified (e.g., worksites 200 lacking electrical transmission and/or generation infrastructure) and/or where it is difficult to transport other fuels. The systems and methods disclosed herein allow for extending and/or maximizing the range and/or the time of operation of fuel cell machines 100 by operating the fuel cell machine 100 beyond the depletion of fuel cell fuel and nearly to depletion of the charge in the battery 118. Furthermore, the capacity of battery energy to the capacity of the fuel cell energy may be advantageous to operate the fuel cell machine 100, as disclosed herein.

By the fuel cell machine 100 and the ECM 130 disclosed herein, the viability of fuel cell machines 100 for construction, mining, farming, and other activities is improved, by overcoming limits on their usage time between refueling and/or recharging. The ECM 130 and operation of the fuel cell machine 100 disclosed herein allows for relatively long times and/or ranges between refueling and/or recharging. Thus, fuel cell machines 100 can be deployed at the worksite 200 and operators will be able to operate the fuel cell machines 100 for relatively long periods of time to complete tasks at the worksite 200. The increased usable range and operating times of fuel cell machines 100, as disclosed herein, provides for improved efficiency and usage rates of fuel cell machines 100. This leads to improved levels of worker and capital efficiency, greater uptime and greater field usage of construction equipment, and greater efficiency of construction, mining, agriculture, and/or transportation projects.

Although the systems and methods of fuel cell machines 100 are discussed in the context of a mining trucks and other mining machinery, it should be appreciated that the systems and methods discussed herein may be applied to a wide array of machines and vehicles across a wide variety of industries, such as construction, mining, farming, transportation, military, combinations thereof, or the like. For example, the range and/or operating time extension mechanism disclosed herein may be applied to a compactor in the paving industry or a harvester in the farming industry.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A machine, comprising:
a motor;
a fuel tank configured to hold fuel;
a fuel tank controller configured to report an amount of fuel in the fuel tank;
a fuel cell configured to power the motor using fuel held in the fuel tank;
a battery configured to power the motor;
a battery controller configured to report an amount of charge in the battery; and
an engine control module (ECM) configured to:
start performing a task, the task including operating the motor using one or both of the of the fuel cell and the battery;
receive, from the fuel tank controller, a first indication that the fuel has been depleted;
continue, based at least in part on the first indication that the fuel has been depleted, performing the task using the battery;
receive from the battery controller a second indication that the battery is within a threshold level of being depleted; and
cause, based at least in part on the second indication that the battery being within the threshold level of being depleted, the task to be halted.

2. The machine of claim 1, wherein an energy capacity of the battery relative to an energy capacity of the fuel when the fuel tank is full is about 0.5 or greater.

3. The machine of claim 1, wherein the ECM is further configured to:
move, based at least in part on the second indication that the battery is within the threshold level of being depleted, the machine to a refueling/charging station.

4. The machine of claim 1, further comprising an energy gauge, wherein the ECM is further configured to:
determine a total energy available to operate the machine; and
cause to display, via the energy gauge, the total energy available to operate the machine.

5. The machine of claim 4, wherein, to determine the total energy available to operate the machine, the ECM is further configured to:
receive, from the fuel tank controller, a third indication of a remaining amount of fuel cell fuel in the fuel tank;
determine a first amount of energy associated with the remaining amount of fuel cell fuel in the fuel tank;
receive, from the battery controller, a fourth indication of a remaining amount of charge in the battery;
determine a second amount of energy associated with the battery based at least in part on the remaining amount of charge in the battery; and
determine that the total energy available to operate the machine based at least in part on the second amount of energy.

6. The machine of claim 4, wherein the ECM is further configured to:
transmit, to an electronic device, a third indication of the total energy available to operate the machine.

7. The machine of claim 4, wherein the ECM is further configured to:
determine, based at least in part on the total energy available to operate the machine, an estimated remaining time of operation; and
cause to display the estimated remaining time of operation on the energy gauge.

8. The machine of claim 1, further comprising:
an antenna, wherein to start performing the task, the ECM is further configured to:
receive a wireless signal via the antenna; and
determine, based at least in part on the wireless signal, that the machine is to perform the task autonomously.

9. A method of operating a machine, comprising:
performing, by the machine, a task using energy from one or both of a fuel cell and a battery;
determining that a fuel cell fuel for operating the fuel cell has been depleted;
continuing, based at least in part on the fuel being depleted, performing the task using energy from the battery;
determining that the battery is within a threshold level of being depleted; and
moving, based at least in part on the battery being within the threshold level of being depleted, the machine to a refueling/charging station.

10. The method of claim 9, further comprising:
receiving, from a fuel tank controller, an indication that the fuel has been depleted.

11. The method of claim 9, further comprising:
receiving, from a battery controller an indication that the battery is within the threshold level of being depleted.

12. The method of claim 9, further comprising:
determining a total energy available to operate the machine; and
causing to display, on an energy gauge, the total energy available to operate the machine.

13. The method of claim 12, wherein determining the total energy available to operate the machine further comprises:
receiving, from a fuel tank controller, an indication of a remaining amount of fuel cell fuel in the fuel tank;
determining a first amount of energy associated with the remaining amount of fuel cell fuel in the fuel tank;
receiving, from a battery controller, an indication of a remaining amount of charge in the battery;
determining a second amount of energy associated with the battery based at least in part on the remaining amount of charge in the battery; and
determine that the total energy available to operate the machine based at least in part on the second amount of energy.

14. The method of claim 12, further comprising:
transmitting, to an electronic device, a third indication of the total energy available to operate the machine.

15. The method of claim 9, further comprising:
receiving a wireless signal via an antenna; and
determining, based at least in part on the wireless signal, that the machine is to perform the task autonomously.

16. A controller of a machine, comprising:
one or more processors; and
one or more computer-readable media storing computer-executable instructions that, when executed by the one or more processors, cause the one or more processors to:
receive, from a fuel tank controller, a first indication of a remaining amount of fuel cell fuel in a fuel tank;
determine a first amount of energy associated with the fuel cell fuel based at least in part on the remaining amount of fuel cell fuel in the fuel tank;
receive, from a battery controller, a second indication of a remaining amount of charge in a battery;
determine a second amount of energy associated with the battery based at least in part on the remaining amount of charge in the battery;
determine that a total energy available to operate the machine based at least in part on the second amount of energy; and
cause to display, on an energy gauge, the total energy available to operate the machine.

17. The controller of the machine of claim 16, wherein the computer-executable instructions, when executed by the one or more processors, cause the one or more processors to:
transmit, to an electronic device, a third indication of the total energy available to operate the machine.

18. The controller of the machine of claim 16, wherein the computer-executable instructions, when executed by the one or more processors, cause the one or more processors to:
determine, based at least in part on the total energy available to operate the machine, an estimated remaining time of operation; and
cause to display the estimated remaining time of operation on the energy gauge.

19. The controller of the machine of claim 16, wherein the computer-executable instructions, when executed by the one or more processors, cause the one or more processors to:
determine, based at least in part on the first indication of the remaining amount of fuel cell fuel in the fuel tank, that the fuel cell fuel is depleted;
determine, based at least in part on the second indication of the remaining amount of charge in the battery, that the battery is within a threshold level of being depleted; and
move, based at least in part on the battery being within the threshold level of being depleted, the machine to a refueling/charging station.

20. The controller of the machine of claim 16, wherein the computer-executable instructions, when executed by the one or more processors, cause the one or more processors to:
determine, based at least in part on the first indication of the remaining amount of fuel cell fuel in the fuel tank, that the fuel cell fuel is depleted;
determine, based at least in part on the second indication of a remaining amount of charge in the battery, that the battery is charged beyond a threshold level; and
operate, based at least in part on the battery being charged beyond a threshold level, the machine to perform a task.
